(19) United States
(12) Patent Application Publication
(10) Pub. No.: US 2019/0124890 A1
(43) Pub. Date: May 2, 2019

(54) DOG HARNESS WITH INTEGRATED SUPPORT HANDLES AND LOAD DISTRIBUTION GEOMETRY

(71) Applicant: Liy Kath, San Francisco, CA (US)

(72) Inventor: Liy Kath, San Francisco, CA (US)

(21) Appl. No.: 15/798,403

(22) Filed: Oct. 31, 2017

(51) Int. Cl. A01K 27/00; A01K 1/02

(52) U.S. Cl. CPC A01K 27/002; A01K 1/0263

(57) ABSTRACT

A harness for domestic dogs, brace and mobility support dogs, or service/companion animals. The harness provides multiple handles for balance and stability and for controlling the movement of the dog. D-rings and additional connection points are provided for attaching a leash as well as securing the harness to a wheelchair. The harness provides a chest protector for protection from abrasion and for load distribution at the dog's center of mass. The harness straps are constructed with nylon or polyester webbing material with a mesh padded covering. At the harness connections, plastic buckles are utilized with Velcro straps. The harness geometry is designed to eliminate the leash pulling forces on the dog's hip, neck, and trachea, by focusing the leash pulling forces at the dog's center of mass middle chest area and by more evenly distributing forces and loads across the body, torso, and chest.

### BACKGROUND

Conventional dog collars and leashes apply large amounts of force to the dog's neck, throat, and trachea. Additionally, by applying force at the neck, the dog's hip joints receive repetitive stress which can lead to the development of joint pain, arthritis, and possibly hip dysplasia. A more humane method is the use of a harness which evenly dissipates leash pulling forces and distributes load across the dog's center of mass, body, and torso area.

Another benefit to using a dog harness is for service dogs. With a harness that has multiple handles and braces, a dog owner is better able to receive balance and stability from the animal. A conventional leash does not give the owner a close level of control and support. A harness with multiple handles, braces, and hand holds provides a more closely connected experience and better control. The owner may safely rely on the dog with harness for support and bracing from falls, mobility assistance, and effective direction and leading across busy intersections, navigating public transit systems, etc.

A harness may additionally serve to protect the dog from injury from collision with external objects. A chest protector may be integrated into the harness for protection from abrasion and cuts while traversing in rough outdoor conditions. Dog's that exhibit nervousness or anxiety may benefit from the wearing of a harness. The feeling of evenly applied pressure and protection can help to calm the dog's nerves. Currently available harnesses are not designed to evenly distribute load and are ill-fitting for the dog. A better solution is to have a fully adjustable harness with nylon or polyester webbing straps, nylon or acetal plastic buckles, and Velcro overlay enclosures to eliminate vibrational noise issues at the plastic buckle connection points, and a load distribution geometry which dissipates leash pulling forces across the dog's center of mass.

### SUMMARY

The presently described dog harness provides a means to more humanely control the animal as well as allows for better support and bracing for use with a service animal. The harness evenly distributes leash pulling forces at the dog's torso and center of mass, instead of at the neck. The overall harness geometry and design is based on the mathematical theory that dogs carry more mass on their front legs and their center of mass is in the middle of the chest. Therefore, the harness loads and leash pulling forces are applied and focused precisely at the dog's center of mass at the middle chest area. A preferred embodiment of the load distributing design and geometry is a woven fabric harness top load distribution area with integrated handles and leash connection points, front and rear pairs of padded webbing straps, and an integrated load dissipating chest protector.

Multiple handles, braces, and hand holds are integrated into the harness for the dog owner's support in bracing him or herself, and to aid in controlling the animal. At least one or more metal D-rings, or circular ring, leash attachments are located on the harness top load distribution area for attaching a leash. There are multiple leash attachment points on the harness for a leash, as well as other attachments, such as a short handle. The harness may also be connected and used with a wheelchair. The harness may additionally be secured inside an automobile with a seat belt leash attachment. Light reflective coatings or reflectors, for safety during nighttime, may be integrated into the front webbing straps, on the top middle part of the top harness area, along the dog's back. A removable or integrated storage pocket may be provided on the harness.

An integrated chest protector, preferably made with Kevlar fabric, is provided for even load distribution across the chest and stomach, as well as protection from abrasion. The chest protector employs an outer ridge shaped contoured surface or stitching for rigidity and shape, and to reduce catching on external objects, whereas the contours or ridges run in the direction of the dog's movement, from front to rear. The interior surface of the chest protector is lined with soft mesh honeycomb fabric padding for a comfortable fit. Harness straps may be preferably constructed with synthetic, nylon or polyester, webbing material and fitted with an anti-static mesh or honeycomb mesh fabric padding sock-like enclosure. Mesh honeycomb padding is integrated throughout the harness for the dog's comfort, breathability and proper fit. The mesh honeycomb fabric padding additionally functions to prevent hair loss from rubbing or chaffing by the harness. Non-slip features are provided in the harness to prevent rotation and movement on the dog's body. The harness connections may preferably utilize plastic buckles with Velcro strap overlays to provide a highly secure connection, prevent the strap connection from coming loose, and eliminate vibrational noise which may distract and cause discomfort in the dog. The Velcro strap overlays provide noise-reduction on the buckle connection points and create a more secure fit with the harness.

The harness is easily fitted to the dog by opening at least one of the plastic buckle/Velcro strap overlay connections and sliding the harness over the dog's neck and locating the chest protector underneath the dog's torso at the chest. Adjustability is provided in the nylon or polyester webbing straps and nylon or acetal plastic buckle connectors. The harness may preferably be comprised of four (4) adjustable webbing straps which fit around the dog's torso, chest and back area. The adjustable straps may be opened at the plastic buckle connections. The harness may be sized in medium (M), for twenty (20) to forty-five (45) pound dogs; large (L), for forty-five (45) to ninety (90) pound dogs; and extra-large (XL), for ninety (90) to one-hundred eighty (180) pound dogs. Additional sizes for different dog breeds and weight classes may also be available.

### DESCRIPTION OF THE DRAWINGS

FIG. 1 is a side view of the dog harness as worn by a medium to large size dog. The integrated handles, for supporting the owner or controlling the dog, are shown on the top of the harness along the dog's back. Leash connections rings are shown near the handles. The harness is comfortably secured to the dog by the fully adjustable plastic buckle connections, visible under the YAP brand logo, and a Velcro strap enclosure additionally secures the plastic buckle.

FIG. 2 is a view of the dog harness being used with a service animal guiding the owner using a wheelchair. The wheelchair leash is attached to the top of the harness and held by the owner or may alternatively be attached to the wheelchair. The harness provides a secure connection, safely guides the owner, and provides mobility and support.

FIG. 3 is a bird's eye view of the harness showing the woven fabric top load distribution area, the integrated handles for bracing and support, and the front and rear pair of webbing straps securing the harness to the dog. Here, the owner simply reaches down for the handle to receive balance and stability. Cutouts in the harness top area are visible near the owner's hand where the owner may provide touch back feeling to the dog.

FIG. 4 is a detailed side profile view of the dog harness showing the woven fabric top load distribution area, the integrated longitudinally and transversely mounted handles, metal b-rings/circular ring leash attachment points, front and rear pairs of webbing straps connecting the top and bottom parts of the harness, plastic buckle connections with Velcro overlay enclosures (under the YAP brand logo), the integrated chest protector, and anti-static mesh padding sock-like enclosures over the front and rear webbing straps.

FIG. 5 is an alternate side profile view of the dog harness with the woven fabric top load distribution area, integrated support and mobility handles, multiple circular ring leash attachment points, front and rear pairs of webbing straps, with mesh padding sock coverings, connecting the top and bottom parts of the harness, the plastic buckles for webbing strap adjustability, the Velcro overlay enclosure with YAP brand logo, and the bottom integrated chest protector.

FIG. 6 is a top-down profile view of the dog harness showing the fully laid out woven fabric top load distribution area, the integrated horizontally and longitudinally mounted handles, the interconnecting webbing straps of the front and rear harness straps, multiple metal D-rings/circular ring leash attachment points, the plastic buckle connections with Velcro overlay enclosures and YAP brand logo, mesh padding sock-enclosures visible on the front pair of webbing straps, and the integrated cushioned chest protector.

FIG. 7 is a bottom profile view of the dog harness showing the integrated chest protector and contoured surface or stitching, the rear pair of webbing straps with mesh padding sock-enclosures, the front pair of webbing straps connected to the chest protector area that flares out to contour to the dog's chest, and the underside of the top woven fabric load distribution area. A detailed view is provided of the Kevlar fabric inside the chest protector.

FIG. 8 is a front facing profile view of the dog harness with top mounted handles, top mounted circular ring leash connection points, plastic buckle connectors with Velcro overlay enclosures on the rear webbing straps, the front webbing straps with mesh padding sock-enclosure coverings, and the integrated chest protector showing the comfortable interior surface padding for load distribution.

FIG. 9 is a rear facing profile view of the dog harness with top mounted handles, top mounted metal D-ring leash connection point, rear webbing strap plastic buckle connectors with Velcro overlay enclosures, mesh padding sock enclosures over the front and rear webbing straps connecting the top woven fabric load distribution area to the bottom mounted integrated chest protector with comfortable interior surface padding.

FIG. 10 is a close-up view of a rear webbing strap plastic buckle connection with Velcro overlay enclosure (at the YAP brand logo) and mesh padding sock-enclosure, a metal D-ring leash connection point, integrated handle mounted on the top woven fabric load distribution area. Additionally, a detail view is provided of the adjustable plastic buckle rear webbing strap connection point with the Velcro overlay enclosure and removable YAP brand logo. A layered fabric cross-sectional view is also provided.

FIG. 11 shows a close-up view of one of the integrated handles, a flap and button strap for tie down and adjustability, and a circular/D-ring leash connection point. Also shown are the various leashes: a short rope handle, an automobile/car seat belt connector, and a service animal wheelchair leash. A hand position is shown on the integrated top mounted handle.

FIG. 12 is a detail view of the integrated handles showing various hand hold positions and an exemplary leash connection point. The owner may grip the longitudinally mounted handle, on top of the dog harness, as shown, or alternatively, the owner my reach for the horizontally mounted handle strap.

### DETAILED DESCRIPTION

The presently described YAP brand dog harness with integrated support handles is of the highest quality and most technically advanced design available to dog owners on the market. Dog owners everywhere will find this harness the humane choice for walking their best friend. The integrated support handles provide service dog owners with reliable support and bracing points. A variety of (steel with nickel-plated finish, or zinc-plated steel) D-ring or circular ring leash connection points are available for attaching conventional leashes, short handle leashes, car/automobile seat belt leashes, or wheelchair leashes. The harness was developed with advanced mathematical theory to calculate and precisely apply leash pulling forces within the dog's center of mass middle chest area. This breakthrough load distribution design geometry eliminates stress on the dog's neck, trachea, and hip joints, therefore avoiding the development of early onset hip dysplasia. Leash pulling forces are evenly applied and distributed throughout the dog's torso area through the padded harness contact points. The harness is fully adjustable with nylon or acetal plastic buckles, webbing straps, and Velcro strap overlays, which additionally function to secure the harness and reduce vibrational noise. The harness comes equipped with an integrated padded Kevlar chest protector to distribute load at the dog's chest and stomach area, and to protect the dog from injury or abrasion from striking external objects. Light reflective coatings are applied to the harness straps for added safety during nighttime. With this YAP brand dog harness, a dog and his owner are safe, comfortable, and secure.

The dog harness described here has specific features which make it ideal for service dog use. The owner will find an easily accessible, large handle, running longitudinally along the dog's back from front to rear. The handle is easy to reach for and intuitively mimics the feel of a handle on a backpack, briefcase or piece of luggage. However, the handle allows the owner to seriously brace and support him or herself in situations where balance and stability are needed. The owner simply reaches down for the dog, grabs onto the handle and is given all the support their canine best friend can provide. An additional handle is easy to find in the horizontally mounted position, running from left to right across the harness on the dog's back. The horizontally mounted handle provides an alternative hand position for the dog owner's personal preference and comfort. The horizontal handle feels in the owner's hands very much the same as gripping the dog by the collar. However, unlike grabbing the dog by the collar and exerting extreme forces on the dog's neck and trachea, the horizontal handle evenly and humanely distributes forces through the harness and across the dog's torso and middle chest area.

Another ideal situation for using the harness is for an owner in a wheelchair with a service dog. The harness may be used to pull and guide a physically disabled person in a wheelchair. This helps the owner with mobility tasks and reduces the amount of effort required to move the wheelchair. The owner simply attaches a wheelchair leash to the harness at one of the available leash connection points and trains the dog to lead and guide the way. The owner is given a close connection to the dog through the harness and the load of the owner and wheelchair are evenly distributed across the dog's torso. The wheelchair leash position is easily adjustable to suit the owner's comfort, whether needed on the right or left side, the owner will find a leash connection point that fits.

The harness is fully adjustable and is intuitively designed to fit a medium to large sized dog. The proper harness size is selected based upon the weight of the owner's dog. Available sizes are: medium (M), twenty (20) to forty-five (45) pounds; large (L), forty-five (45) to ninety (90) pounds; and extra-large (XL), ninety (90) pounds and larger. Additional sizes to fit different breeds and other weight classes may also be available. Fitting the harness to the dog is achieved by, first opening one of the Velcro overlay enclosures and the plastic buckle connecting one of the rear webbing straps. Second, the harness is slid over the dog's head and neck and the chest protector is located at the dog's chest, and the top harness load distribution area, integrated handles, and leash connection points, are located at the dog's back. The dog's front legs should be properly located through the front openings between the front and rear pairs of webbing straps. Third, the harness is adjusted by tightening or loosening the plastic buckles on the webbing straps until the harness fits the dog's torso and chest snugly. Fourth, the plastic buckles are snapped together and the Velcro overlay enclosures are tightened and closed. The harness is now ready to be put into service for providing a safe and humane means of walking the dog, and for use in bracing and supporting the owner, as well as for wheelchair and service dog use.

The overall design aesthetic of the harness is high-quality construction and manufacture, humane control, comfort and security, and intuitive mobility and support. The owner chooses to use this harness because he or she cares about the dog's health and wants their best friend to be happiest. The owner values the relationship with the dog and therefore appreciates using the most advanced harness available. The technical features of the harness are naturally understood and utilized by the owner in his or her normal daily routines with the dog. The harness functionality is easily integrated into the dog and owner's everyday life existence. For example, the owner may safely travel with their dog in the car and go for a walk a new park. The dog is reliably and comfortably secured at the car seatbelt during travel, with the available car/automobile seat belt connector. At the park, the owner attaches a leash of his or her preference, and walks the dog safely in unexplored lands.

For nervous and anxious dogs, the harness provides comfort and security to calm the nerves. The harness applies pressure to the dog's chest, torso, and around the back area, giving the dog a swaddle-like sensation. The snug, comfortable, contoured fit applied at specific pressure points will reduce panting, high-heart rate, and whining as the dog feels secure in the harness. Additionally, while controlling the dog with a leash, or via the integrated handles, the dog will feel an evenly distributed tugging pressure across the body and torso, which is far more humane than choking at the neck. A dog that is humanely restrained is also far less likely to act out aggressively and will reward the owner with obedient behavior.

The harness is ideal for long walks, trail hiking, or other outdoor excursion as the harness may come equipped with pockets to hold food, waste bag(s), collapsible water bowl, dog toys, etc. The interior surfaces of the harness are lined and padded with a breathable, soft, honeycomb mesh, foam padded fabric for the most comfortable fit that supports and contours to the dog's body. The mesh padding allows breath-ability and airflow to keep the dog cool, while also providing warmth and protection from cold weather conditions. Additionally, the mesh keeps the harness in a snug fit and prevents rotation, and excessive movement, etc. The mesh also prevents hair loss by eliminating rubbing and chafing.

The harness design geometry is based on mathematical theory regarding the dog's center of mass and the laws of physics. Newton' third law states that when one body exerts force on a second body, the second body simultaneously exerts a force equal in magnitude and opposite in directions on the first body. When applied to the dog harness, the forces exerted on the leash connection points, or the integrated handles, are transferred into the harness load distribution design geometry. The forces exerted at the top harness woven fabric load distribution area are transferred to the chest protector via the front and rear pairs of webbing straps. At the chest protector, the dog's body exerts a force equal in magnitude and in opposite direction to the applied leash pulling force. In other words, as the leash is pulled up, the dog's body pushes down. Based on the mathematical theory that a dog's center of mass is in the middle of the chest, as dogs carry more mass on their front legs, the harness geometry therefore evenly distributes leash pulling forces and loads at this middle chest center of mass area. A preferred embodiment of this load distribution design geometry is the harness integrated chest protector, which receives forces and loads from the front and rear pairs of webbing straps, and the harness top woven fabric load distribution area with integrated handles and leash connection points.

The harness design geometry is also presented as an improvement to conventional leashes which apply force at the dog's neck. When force is applied at the dog's neck, this force torques the dog's body around the center of mass, and the dog tends to apply a reactive, stabilizing force at the rear in the hip joints. As the dog owner pulls at the neck, the dog braces with their hind legs. Repetitive forces and stress at the hip joints can lead to the development of joint pain, arthritis, and hip dysplasia. By applying forces evenly at the dog's center of gravity or center of mass, the presently described harness solves the problem of torqueing a dog at the neck, and causing repetitive stress on the hip joints.

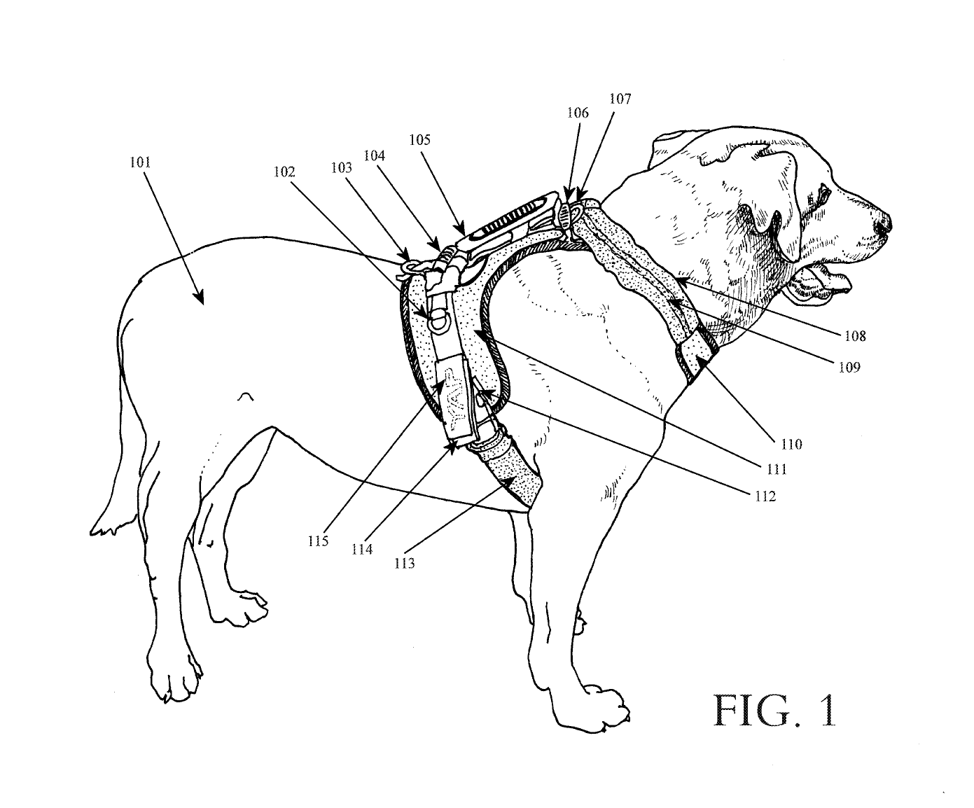

In FIG. 1, a medium to large size dog 101 is shown wearing the properly adjusted harness providing a comfortable and secure fit. The woven fabric top load distribution area 111 is fitted on the dog's back and flares out around the torso behind the dog's front legs. The harness is secured with the front webbing straps 109 and rear webbing straps 113. The front and rear webbing straps are enclosed in mesh padding sock covering 108 and 113 respectively. The front webbing strap 109 connects to the integrated chest protector, a portion visible at 110. The rear webbing straps 113 are adjustable and open at the plastic buckle connection point 112. The plastic buckle 112 is further secured with Velcro overlay enclosure 114 and removable YAP brand logo or personalize-able nameplate plate 115. Leash connection points with metal circular rings or D-rings are available at 102, 103, and 107. Integrated support handles at the top load distribution area are shown with the transversely mounted handle 104, the longitudinally mounted handle 105, and a flexible handle 106. The overall load distribution geometry is shown to evenly dissipate leash pulling loads, or bracing and support loads applied at the integrated handles, across the dog's center of mass, torso, body, chest and stomach area.

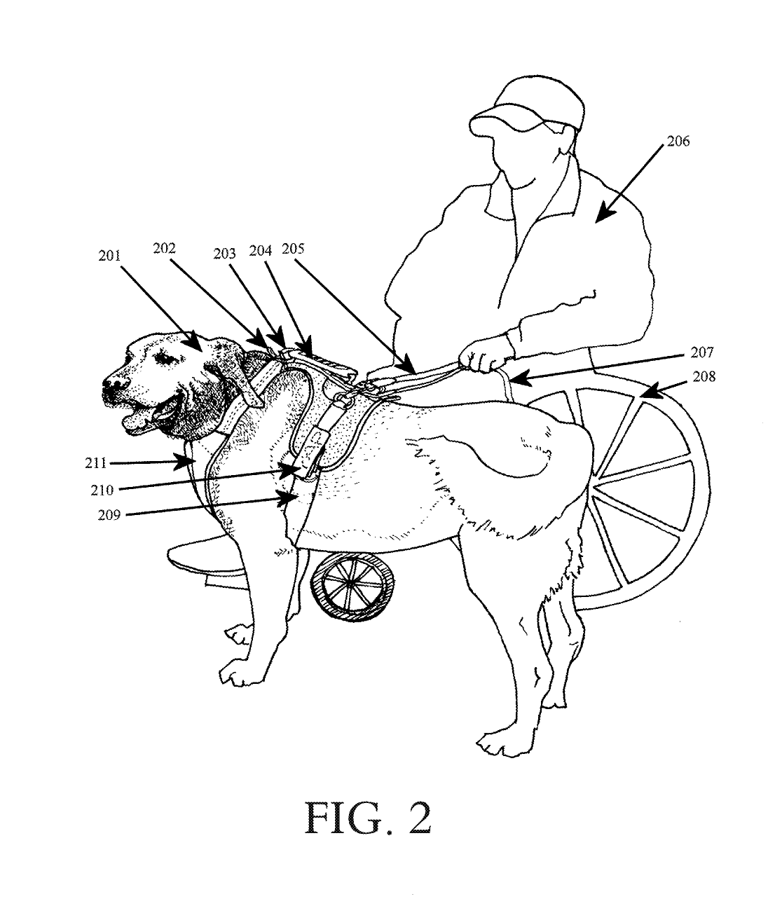

In FIG. 2 a service dog 201 is shown with an owner in a wheelchair 208. The owner 206 is able to control the dog with a hand on the wheelchair leash 207 and 205, and is provided guidance and mobility support. Further support and control is available by reaching for the integrated handles 203 and 204. An additional leash connection point is available at 202. The harness evenly distributes leash pulling forces and load across the dog's torso and center of mass through the integrated chest protector 211 and adjustable webbing straps 209, with mesh padding sock enclosures. The plastic buckle connection point is secured with the Velcro overlay enclosure 210. Leash pulling forces applied by the dog owner 206 through the leash 205 are exerted at the leash connection point at the harness top woven fabric load distribution area which flares out around the dog's torso. The forces are distributed through the front and rear pairs of webbing straps 209 and evenly applied at the chest protector 211 and the dog's center of mass middle chest area.

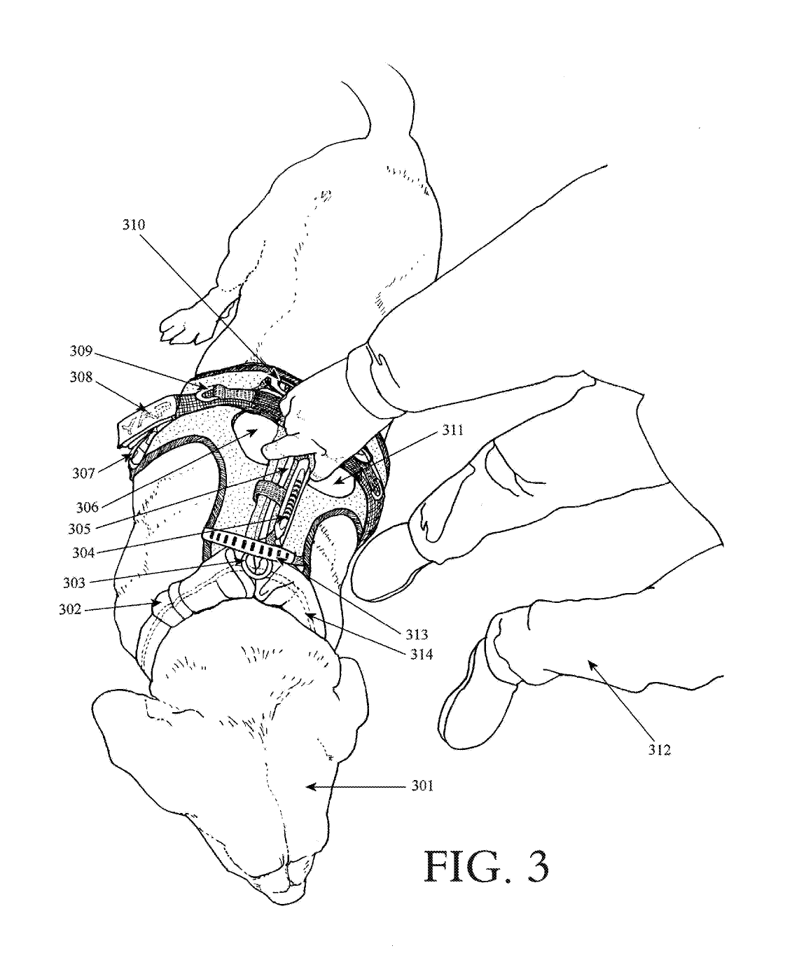

A bird's eye view of the harness is provided in FIG. 3 showing the owner 312 gripping the harness at the integrated longitudinally mounted handle 304. Cutouts 306, 311 in the woven fabric top harness load distribution area allow the owner's hand to provide touch back and feeling to the dog 301. Alternative hand hold positions are available at the transversely mounted handle 310 or at the front mounted flexible handle 313. The owner may attach a leash to the harness at the leash connection points, preferably embodied as metal circular rings or D-rings 309 and 303. The harness is comfortably secured to the dog and load is evenly distributed through adjustable webbing straps, the front straps at 302 and 314, as shown with anti-static mesh padding sock enclosures. The rear webbing straps running around the dog's torso are secured with a plastic buckle connection 307 and Velcro overlay enclosure 308. A light-reflective strip 305 is integrated into the top of the harness for added safety at night. An additional light reflective strip may be integrated into the front webbing straps at 314 (dotted lines). Restraint loads or bracing and support loads applied by the dog owner 312 at the top mounted handle 304 are distributed across the harness top woven fabric load distribution area, which flares out around the dog's torso, and connects to the integrated chest protector through the front 302, 314 and rear pairs of webbing straps. Loads applied at handle 304 are therefore evenly distributed across the dog's body and center of mass middle chest area.

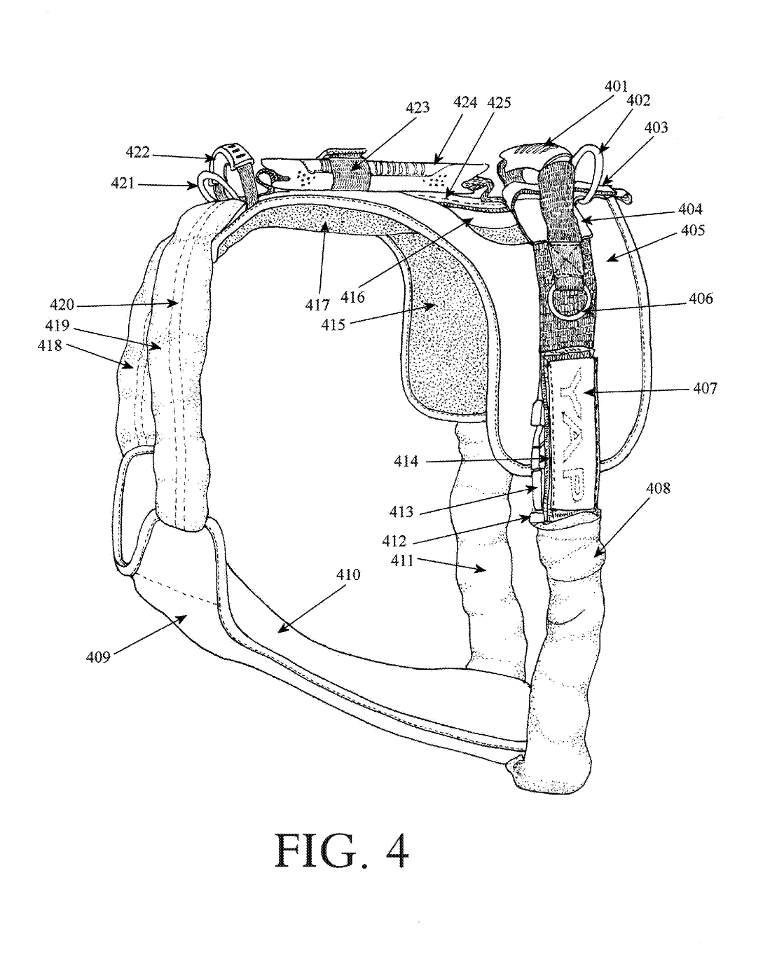

FIG. 4 is a detailed side profile view of the harness woven fabric top load distribution area 405, the rear pair of webbing straps 408 and 411, the front pair of webbing straps 418 and 419, and the integrated chest protector 409 for evenly distributing load at the dog's center of mass, chest and stomach area. The interior surface of the harness top evenly distributes load through a padded breathable mesh at 415 and 417. Cutouts in the top load distribution area are available at 416 for the owner's hand, to feel the dog, and for the dog's comfort and breathability. The transversely mounted handle 401 and longitudinally mounted handle 424 are available for the owner's support and mobility control. A soft padding surface 404 is provided for the owner's knuckles when gripping the handle 401. A webbing strap with button connection 403 may be provided to tie down the handle 401 and leash connection point 402. Additionally, a flexible handle is provided at 422. The longitudinal handle 424 may be secured and tied down with the Velcro strap at 423. Leash connection points are available with metal D-rings at the front of the harness 421, the rear 402, and the sides 406. The harness is secured around the dog's body below the neck with the pair of harness webbing straps 418 and 419. The rear pair of webbing straps 411, 408 run around the dog's torso, are covered with mesh padding sock enclosures, and are adjustable and open at the plastic buckle 413. A steel ring 412 ties together the rear webbing straps with the Velcro overlay enclosure 414 showing the YAP brand logo 407, which may alternatively be personalized with the dog's name. The bottom mounted chest protector 409 may preferably be constructed with Kevlar fabric, and comprises a soft breathable mesh padded interior surface 410. A light reflective strip is provided at 425 and 420, 418 for safety during nighttime.

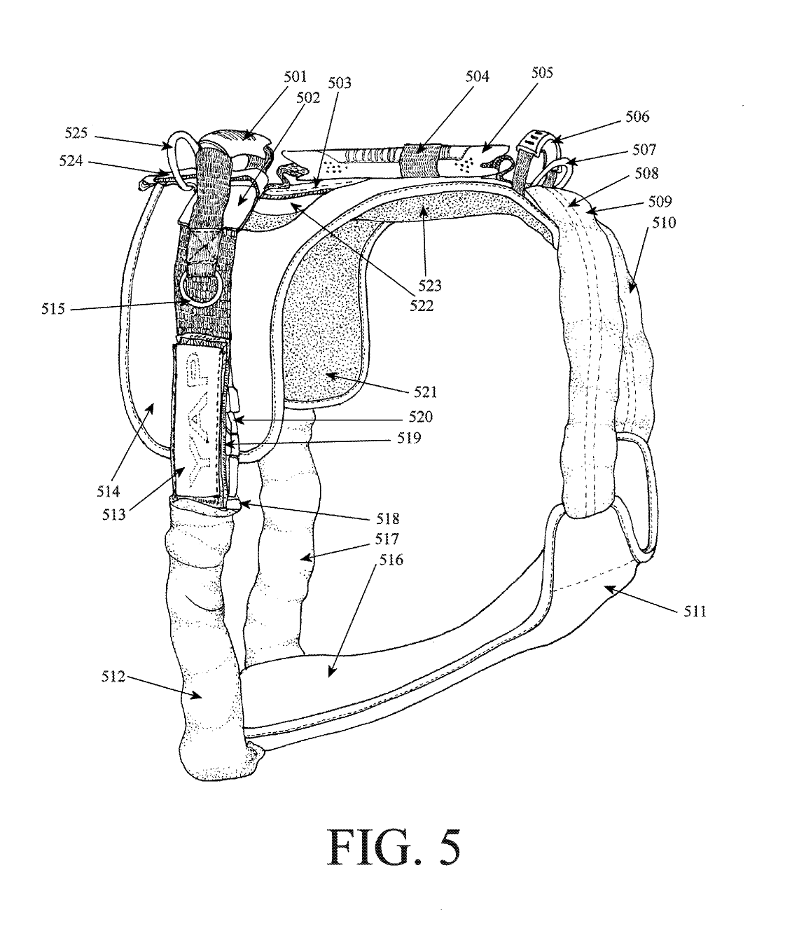

An alternative side view of the harness is provided in FIG. 5. Here the harness woven fabric top load distribution area is shown 514 integrating the rear pair of webbing straps 512 and 517 to the top transversely mounted handle 501, the longitudinally mounted handle 505, and the front pair of webbing straps 509 and 510. A soft cushion material 502 is provided for the owner's knuckles. The handle 501 may be tied down with strap and button 524. An additional flexible hand hold is provided at 506. Leash connection points are provided with metal rings or D-rings at 515, 525, and 507. Harness loads are evenly distributed across the dog's center of mass, and torso at the integrated chest protector 511 with soft cushion padding breathable interior surface 516. The front and rear pairs of webbing straps are enclosed in mesh padding sock enclosures 509, 510, and 512, 517, respectively. The underside of the woven fabric top load distribution area is also lined with breathable cushioned mesh padding 523, 521. The harness rear webbing straps are adjustable and may open at plastic buckles 520, available on each side, left and right. The plastic buckle is further secured with Velcro overlay enclosure 519 and removable YAP brand logo 513, which may alternatively be personalized with the dog's name. The Velcro overlay enclosure loops around the metal ring 518 to secure the plastic buckle 520 with Velcro at 519. The Velcro overlay enclosure further reduces noise and vibration at the plastic buckle connection area. Light reflective strips/coatings may be provided at 503, and along the front pair of webbing straps at 508.

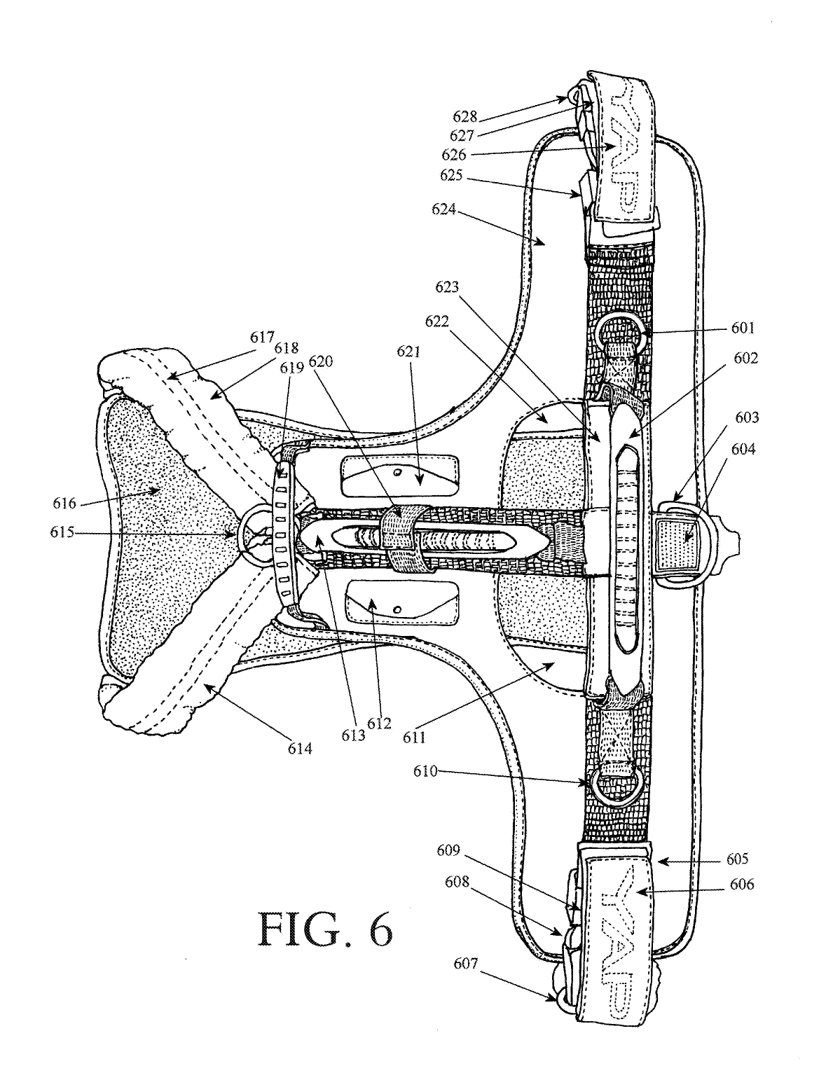

The top-down view at FIG. 6 shows the detail of the top harness woven fabric load distribution area 624 which flares out around the dog's torso and center of mass. The front pair of webbing straps are shown at 618 and 614 which wrap around the dog below the neck and connect the harness top 624 to the bottom mounted integrated chest protector 616. The rear pair of webbing straps wrap around the dog's torso and connect the chest protector to the top harness area via the plastic buckles 608 and 625. The rear webbing straps integrate into the harness top woven fabric load distribution area along the flare outs and webbing strap that runs along and underneath the transversely mounted handle 602. Soft padding for the owner's knuckles is available at 623. The plastic buckles 608, 625, are further secured with Velcro overlay enclosures 609, 627, respectively. The Velcro overlay enclosures webbing straps loop through the metal rings 607, 628 in order to tie down the plastic buckles 608, 625. The removable YAP brand logo 606, 626, is affixed with Velcro to the webbing straps. Left and right side leash connection points are available at 601 and 610 with metal ring or D-rings secured in webbing strap fastened to the harness webbing with box-X stitching. A cutout is provided at 611, 622 in the top woven fabric load distribution area 624 for the dog's comfort, breathability and for the owner to provide touch interaction to the dog's back. A rear leash connection point is provided at the D-ring 603, which may be tied down with the strap 604, by folding the D-ring under the handle 602 and running the strap 604 up and over the handle and D-ring and securing to button connection. The longitudinally mounted handle is shown at 613 running along the top of the harness and affixed to webbing strap integrating the front and rear pairs of webbing straps. The handle 613 may be tied-down with Velcro strap 620. An additional flexible handle is provided in the front of the harness at 619 near the front leash connection point or D-ring at 615. Pockets for storage of small items are shown at 621 and 612.

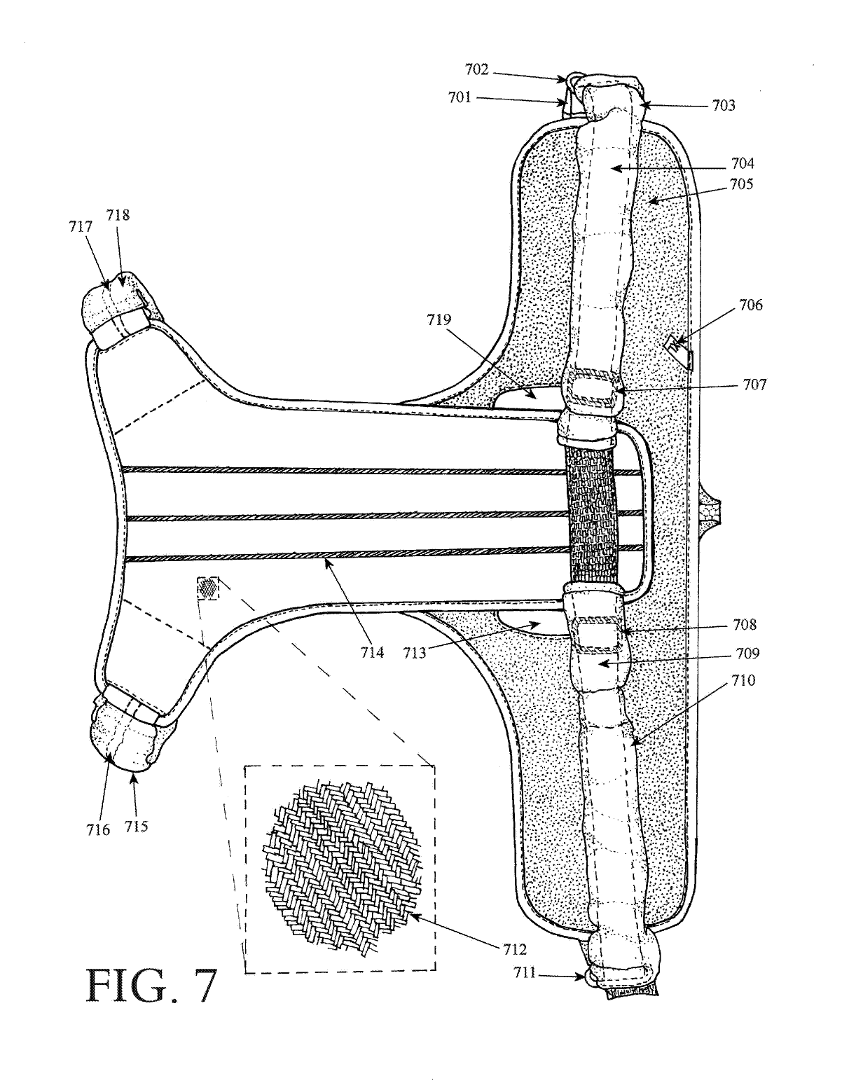

The bottom side of the harness is shown in FIG. 7 with the chest protector 714 and contoured surface stripes running in the direction of travel to give the chest protector rigidity and to eliminate catching on exterior objects. The interior Kevlar fabric texture is illustrated at 712. The chest protector distributes load at the dog's center of mass, middle chest, and stomach area and integrates the front pair of harness straps 715, 718 with the rear pair 704, 709. The rear webbing straps are adjustable with plastic buckles at 707, 708. The rear webbing straps are enclosed in mesh padding sock-like enclosures 707, 710 for further padding, load distribution, and breathability for the dog's comfort. The plastic buckle at 701 is further secured with Velcro strap overlay which loops through the metal ring 702, 711 at the webbing strap. The soft padded underside surface of the top harness load distribution area is visible at 705. A garment tag 706 is available for size, brand, and other information. Cutouts in the top harness area are provided at 713, 719 for the dog's comfort, breathability, and for the owner to provide touch to the dog's back.

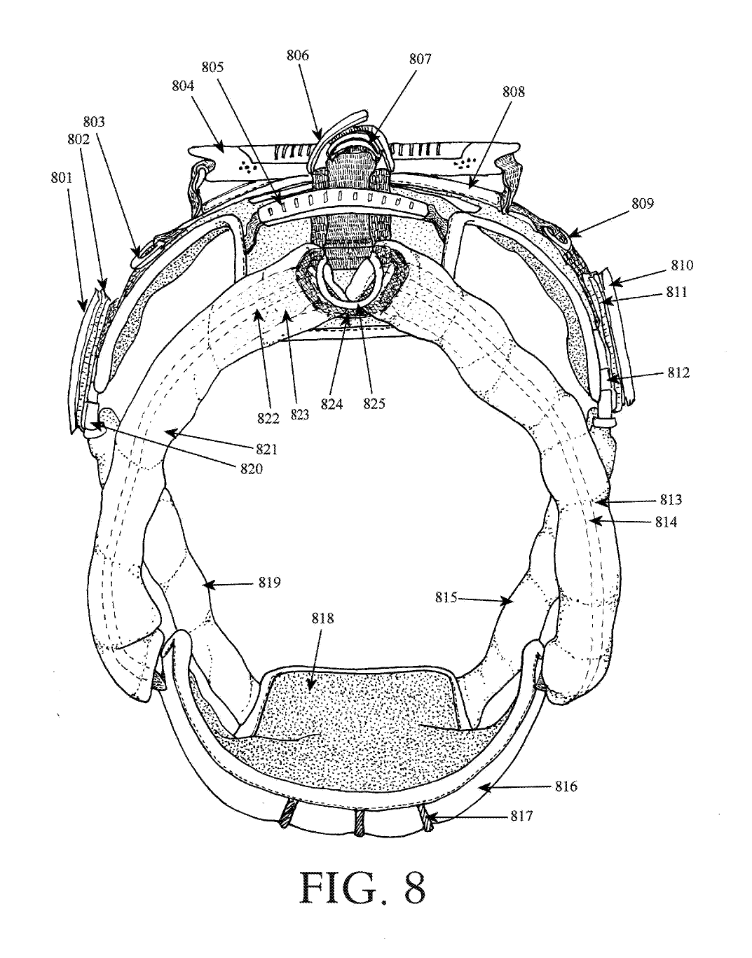

In FIG. 8 a front-facing profile view is given of the dog harness with the prominent front pair of webbing straps 814 and 822, integrating the top harness load distribution area 808 with the bottom mounted chest protector 816, with contoured surface stitching 817, and soft padded interior surface 818. The front pair 814, 822 (and rear pair) of webbing straps are enclosed in mesh padding sock-like coverings 813, 821/823, respectively. The rear pair of webbing straps 815, 819 connect the chest protector via plastic buckle connections 812, 820 and Velcro overlay enclosures 802, 811, to the integrated webbing strap running along the harness top woven fabric load distribution area. Removable brand logo or personalize-able dog nameplates are provided at 801, 810. Leash connection rings or D-rings 803, 809 are affixed to the webbing strap running along the top of the harness top woven fabric load distribution area. A transversely mounted handle 804 is additionally secured at the webbing strap across the top of the harness. The longitudinally mounted handle 807, running along the dog's back/spine area, may be tied down with Velcro strap 806. An additional flexible handle is provided at 805. The front leash connection D-ring 825 is secured with webbing strap stitched to the top of the harness. A metal bracket 824 integrates and connects the front pair of webbing straps 822, 814 to the webbing strap which runs along the top of the harness.

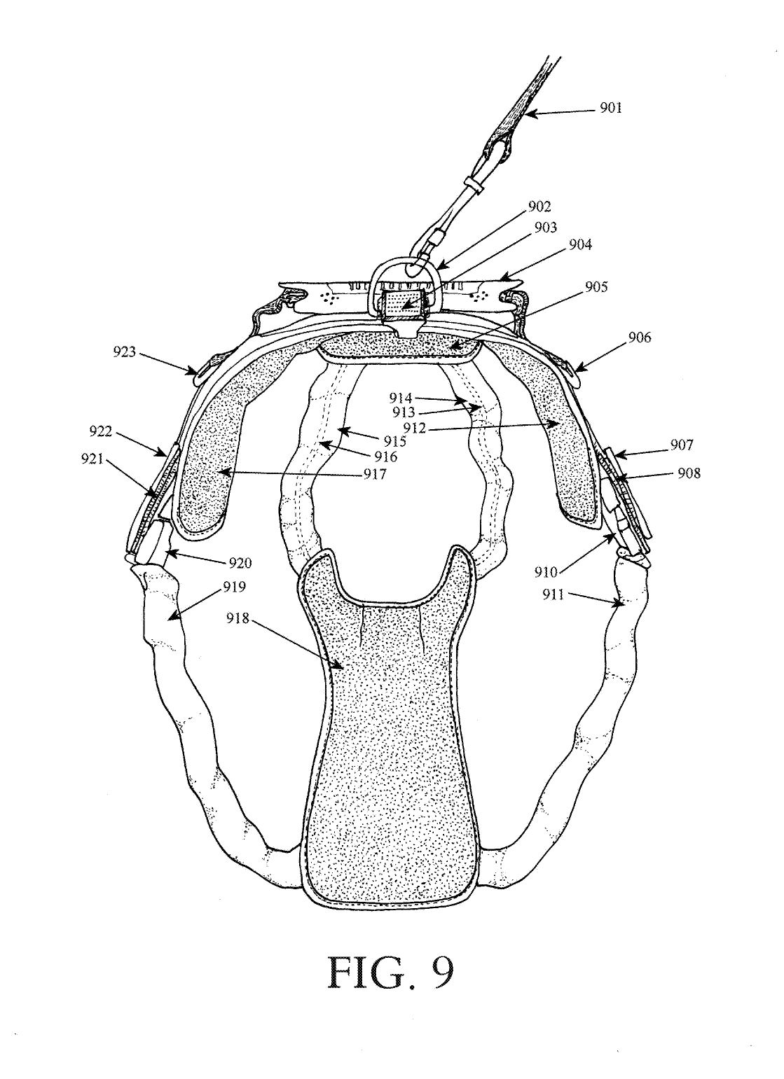

A rear-profile view is illustrated in FIG. 9 prominently displaying the interior padded, load distributing, surface of the chest protector 918. Running out to the left and right side are the rear pairs of webbing straps 911, 919, which secure the harness around the dog's torso between the front and rear legs. The rear webbing straps connect with plastic buckles 910 and 920, which are further secured with Velcro overlay enclosures 908, 921. Brand logo or personalized nameplates are removable with Velcro at 907, and 922. The front of the chest protector is connected to the top of the harness via the front pair of webbing straps 916, 913, which are enclosed in mesh padding sock-enclosures 915, 914. The padded underside of the top harness load distribution area is visible at 905, 912, and 917. Leash 901 connection points or D-rings are provided at 902, 906 and 923. The transversely mounted handle 904 is secured to the top harness load distribution area along webbing strap running to the rear webbing straps. The top handle 904 and D-ring 902 may be tied-down with the Velcro or button strap 904.

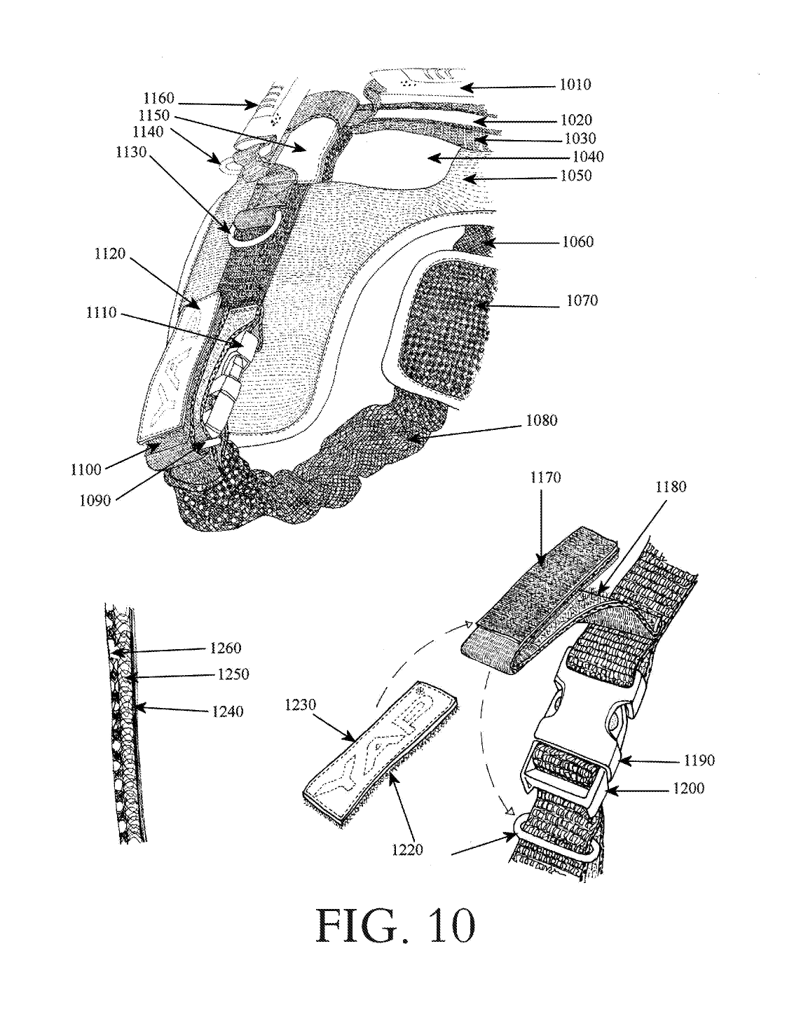

FIG. 10 is a close up view of the plastic buckle 1110 connection point for the rear webbing straps 1080, 1060, whereas the straps are covered in mesh padding sock enclosures. A portion of the chest protector is visible at 1070. The plastic buckle 1110 is further secured with the Velcro overlay enclosure 1100 which loops through ring 1090 at the webbing strap. The brand logo 1120 is removable, and may be personalized with the dog's name. A leash connection point 1130 is shown along the top webbing strap running along the woven fabric load distribution area 1050. A cutout 1040 is provided for breathability and touch-back control. The longitudinally mounted handle 1010 runs along the top of the harness at webbing strap 1030 with light reflective coating 1020. The transversely mounted handle 1160 is affixed to the webbing strap that runs in the direction of around the dog's torso on the top of the harness. A center mounted, additional leash connection ring 1140 is available. Padded surface 1150 protects the owner's knuckles. A cross section view of the padding fabric textures 1240, 1250, and 1260 is provided. A detail view of the plastic buckle 1190 and Velcro overlay enclosure 1180 strap mechanism is provided. The rear webbing straps are secured with the plastic buckle 1190 and fully adjustable 1200. The Velcro overlay feeds through the metal loop (dotted arrows) to tighten down the connection, and is secured at the Velcro 1180. A brand logo or personalizeable nameplate 1230 is removable with Velcro 1220, 1170.

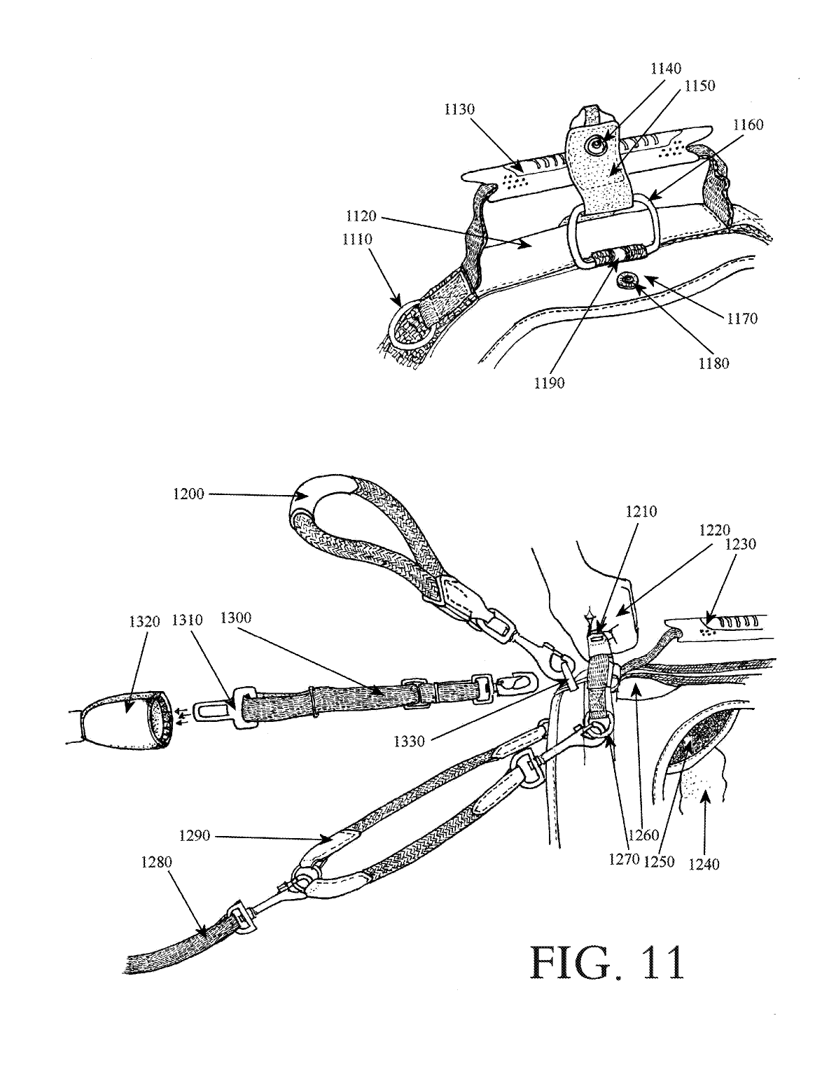

FIG. 11 illustrates the transversely mounted handle 1130 and leash connection point or D-ring 1160 tie-down 1150 mechanism. The strap 1150 may be looped over the D-ring 1160 and secured with the button 1140, 1180. The harness top area is shown at 1170. A soft fabric material is provided at 1120 to protect the owner's knuckles. A light-reflective strip is shown at 1190 for safety during low light conditions. Alternatively, the tie-down 1150 may be looped over the handle 1130 and the D-ring 1160 and secured at the button 1140, 1180. A side circular ring or D-ring is shown at 1110, which is secured with webbing strap stitched with a box-X stitching pattern to the top of the harness. Various leashes are illustrated: the short rope handle 1200 for close support and control, the car/automobile seat belt connector 1300, 1310 for securing the dog and harness inside the car to a typical car seatbelt 1320, and the wheelchair or service dog leash rope 1290 with leash extension 1280 and D-ring connection point 1270. The short rope handle 1200 is connected to the harness at leash connection point 1330, which is preferably embodied as a D-ring or metal circular ring, affixed to the harness webbing with a webbing strap and a box-X stitching pattern. The transversely mounted handle 1210 is shown with hand hold position 1220. The longitudinally mounted handle 1230 is secured to the harness top load distribution area with webbing strap. A cutout 1260 is provided for breathability and touch-back control. The padded underside 1250 of the harness top load distribution area provides comfort to the dog. A portion of a rear webbing strap 1240 is visible and encased in mesh padding sock enclosure for comfort.

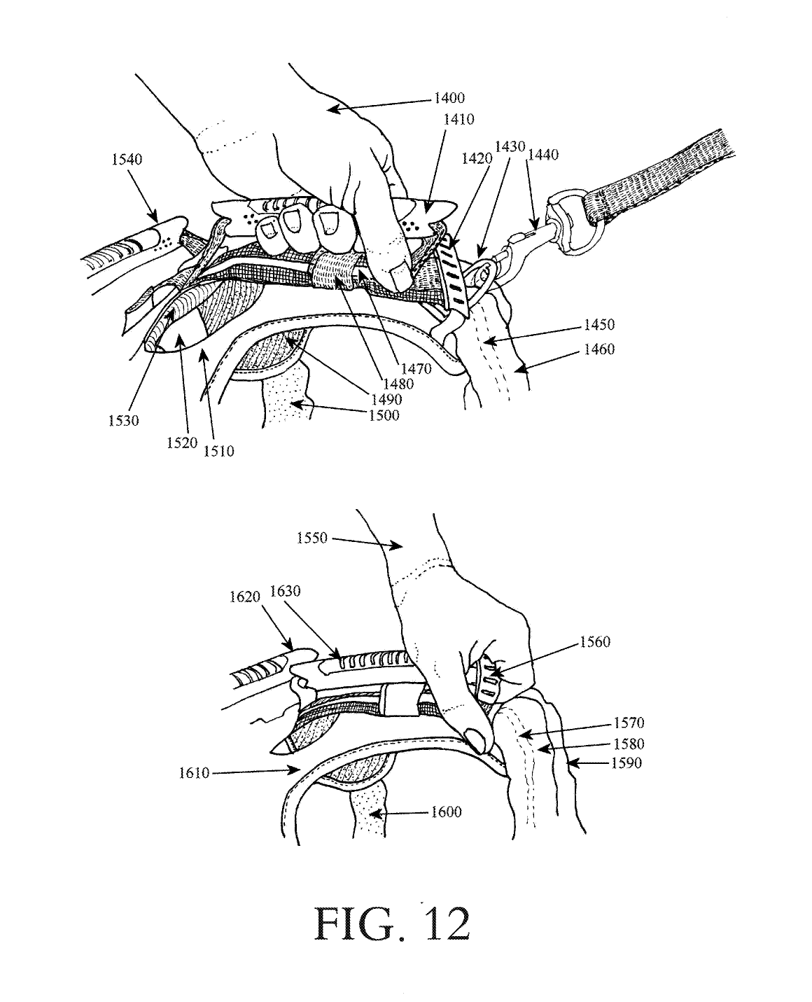

FIG. 12 illustrates the various hand hold positions at the integrated hands and an exemplary leash connection point. The dog owner 1400 may grip the longitudinally mounted handle 1410 and apply force upwards to restrain the dog. The force is applied through the handle 1410, across the top harness woven fabric load distribution area 1510, through the front and rear pairs of webbing straps 1450, 1460, 1500 and is dissipated across the chest protector at the dog's center of mass middle chest area. Similarly, leash pulling forces are applied from the leash 1440 at the leash connection point or circular ring/D-ring 1430 and distributed across the top harness woven fabric load distribution area 1510, front and rear webbing straps 1450, 1460, 1500 and across the integrated chest protector. Loads may also be applied at the flexible handle 1420, or at the transversely mounted handle 1540. The underside of the harness top load distribution area is padded 1490, 1530. A cutout 1520 is provided for breathability and touch back control for petting the dog through the harness top. The front and rear webbing straps are enclosed in mesh padding sock enclosures 1460, 1500 for added comfort and load distribution. The owner 1550 may alternatively grip the flexible handle 1560 and receive bracing and mobility support from the dog. Bracing and support forces are exerted at the flexible handle 1560 and transferred to the top harness woven fabric load distribution area 1610, and the front and rear webbing straps 1600, 1570, 1590 and eventually dissipated at the chest protector and middle chest center of gravity area. The integrated handles 1620, 1630 may also be used for bracing and support during service dog use.

1. A dog harness with integrated support handles and load distribution geometry, comprising:
a top harness load distribution area;
a top mounted handle for bracing, support and mobility control;
a leash connection point;
a front and rear pair of adjustable webbing straps; and
an integrated chest protector;
wherein the harness top load distribution area flares out around the dog's torso, connects the front and rear pairs of adjustable webbing straps with the integrated chest protector, and distributes leash pulling forces and bracing and support loads across the dog's center of mass, torso and middle chest area.

2. The dog harness of claim 1, wherein forces exerted on the leash connection point or top mounted handle are transferred to the top harness load distribution area, front and rear adjustable webbing straps, and integrated chest protector and distributed at the dog's center of mass.

3. The dog harness of claim 1, wherein the harness load distribution geometry prevents torqueing at the dog's neck and repetitive stress at the hip joints by distributing leash pulling forces and harness loads at dog's center of mass.

4. The dog harness of claim 1, wherein the top harness load distribution area integrates a longitudinally mounted support handle in the direction of the dog's spine and a transversely mounted support handle in the direction of left to right around the dog's torso, and wherein the integrated support handles distribute load at the dog's center of mass.

5. The dog harness of claim 1, wherein the leash connection point comprises a metal ring or D-ring integrated into the top harness load distribution area and distributes leash pulling forces at the dog's center of mass.

6. The dog harness of claim 1, wherein the rear pair of adjustable webbing straps are secured with a plastic buckle opening and Velcro overlay enclosure.

7. The dog harness of claim 1, wherein the front and rear pairs of adjustable webbing straps are enclosed in mesh padding enclosures for added comfort, breathability, and load distribution.

8. A dog harness with integrated support handles and load distribution geometry comprising:
a top harness load distribution area;
at least one support handle integrated into the top harness load distribution area;
at least one leash connection point at the harness top area load distribution area; and
a front and rear pair of adjustable webbing straps interconnecting the harness top load distribution area with a bottom mounted chest protector;
wherein leash pulling forces and harness loads are applied at the dog's center of mass and reduce force on the neck, trachea and hip joints; wherein the front pair of webbing straps run underneath the dog's neck area; and wherein the rear pair of webbing straps run around the dog's middle torso area between the front and rear legs.

9. The dog harness of claim 8, wherein forces exerted on the leash connection point or support handle are transferred to the top harness load distribution area, front and rear adjustable webbing straps, and integrated chest protector and distributed at the dog's center of mass.

10. The dog harness of claim 8, wherein the harness load distribution geometry prevents torqueing at the dog's neck and repetitive stress at the hip joints by distributing leash pulling forces and harness loads at dog's center of mass.

11. The dog harness of claim 8, wherein the top harness load distribution area integrates a longitudinally mounted support handle in the direction of the dog's spine and a transversely mounted support handle in the direction of left to right around the dog's torso, and wherein the integrated support handles distribute load at the dog's center of mass.

12. The dog harness of claim 8, wherein leash connection points comprising metal rings or D-rings are integrated into the top harness load distribution area and distribute leash pulling forces at the dog's center of mass.

13. The dog harness of claim 8, wherein the rear pair of adjustable webbing straps are secured with a plastic buckle opening and Velcro overlay enclosure.

14. The dog harness of claim 8, wherein the front and rear pairs of adjustable webbing straps are enclosed in mesh padding enclosures for added comfort, breathability, and load distribution.

15. A dog harness with integrated support handles and load distribution geometry for applying leash pulling forces and harness loads at the dog's center of mass, comprising:
a harness top load distribution area on the dog's back interconnecting a pair of front and rear adjustable webbing straps;
a transversely mounted support handle located on the harness top load distribution area and stitched to webbing strap running around the dog's torso interconnecting the rear left and right side adjustable webbing straps;
a longitudinally mounted support handle located on the harness top load distribution area and stitched to webbing strap running along the dog's spine interconnecting the front and rear adjustable webbing straps;
a plurality of leash connection points integrated into the harness top load distribution area; and
a chest protector interconnecting the front and rear adjustable webbing straps;
wherein the harness top load distribution area flares out around the dog's torso; wherein the rear pair of adjustable webbing straps run around the dog's torso between the front and rear legs; wherein front pair of adjustable webbing straps run underneath the dog's neck area; and wherein the chest protector distributes forces and loads at the dog's center of mass middle chest area.

16. The dog harness of claim 15, wherein forces exerted on the leash connection points or support handles are transferred to the top harness load distribution area, front and rear adjustable webbing straps, and integrated chest protector and distributed at the dog's center of mass.

17. The dog harness of claim 15, wherein the harness geometry prevents torqueing at the dog's neck and repetitive stress at the hip joints by distributing leash pulling forces and harness loads at dog's center of mass.

18. The dog harness of claim 15, wherein leash connection points comprising metal rings or D-rings are integrated into the top harness load distribution area and distribute leash pulling forces at the dog's center of mass.

19. The dog harness of claim 15, wherein the rear pair of adjustable webbing straps are secured with a plastic buckle opening and Velcro overlay enclosure.

20. The dog harness of claim 15, wherein the front and rear pairs of adjustable webbing straps are enclosed in mesh padding enclosures for added comfort, breathability, and load distribution.
